(19) United States
(12) Patent Application Publication
(10) Pub. No.: US 2022/0363472 A1
(43) Pub. Date: Nov. 17, 2022

(54) AUTOMATED TRASHCAN ROVER

(71) Applicant: John Muthusi Mutua, Acworth, GA (US)

(72) Inventor: John Muthusi Mutua, Acworth, GA (US)

(21) Appl. No.: 17/733,402

(22) Filed: Apr. 29, 2022

Related U.S. Application Data
(60) Provisional application No. 63/186,982, filed on May 11, 2021.

(51) Int. Cl. B65F 3/02; B65F 1/14

(52) U.S. Cl. CPC B65F 3/02; B65F 1/1473; B65F 2003/023; B65F 2003/025; B65F 2210/165; B65F 2210/139

(57) ABSTRACT

Apparatuses and systems for an automated trashcan rover for lifting and moving a trashcan. An automated trashcan rover device may include a motor coupled to a plurality of wheels, a gripping means for grasping and lifting the trashcan, and a power source for power operation of the device. A controller is coupled to the motor, gripping means, and power source and is configured to control the lifting and moving of the trashcan.

### CROSS-REFERENCE TO RELATED APPLICATIONS

This application claims the benefit of U.S. Provisional Patent Application No. 63/186,982, filed May 11, 2021, and entitled “AUTOMATED TRASHCAN ROVER,” the entirety of which is hereby incorporated herein by this reference.

### FIELD OF THE DISCLOSURE

This disclosure relates generally to a robotic device specifically configured to move a trashcan from a first predetermined location to a second predetermined location. More particularly the disclosure relates to automated device configured to pick up and move a trash bin from a stored position to a collection position and back to the stored position while simultaneously operating corresponding devices, such as garage door openers or the like.

### BACKGROUND

Currently there are a number of solutions for transporting trashcans. One of these solutions attempts to walk the trashcan to the curb, but this solution fails to meet the needs of the market because some people may be physically unable. Another solution may to hire someone to take the trashcan to the curb, but this solution is similarly unable to meet the needs of the market because it increases the cost of trash collection. Still another solution seeks to utilize family or friends, but this solution also fails to meet market needs because they may not be available.

It would be advantageous to have an apparatus that is automatic. Furthermore, it would also be advantageous to have an apparatus that is provided with a power source that is rechargeable. Still further, it would be advantageous to have an apparatus that is operated via remote coupling with a controller. Therefore, there currently exists a need in the market for an automated device that is configured to pick up and move a trashcan to a collection area for pickup and from the pickup area to a storage position after collection.

It is with respect to these considerations and others that the disclosure made herein is presented.

### SUMMARY

The present disclosure relates to apparatuses, systems, and methods for providing an automated trashcan rover.

The disclosed automated trashcan rover advantageously fills the aforementioned deficiencies by providing an automated rover-like device for transporting a trashcan for collection.

According to some aspects, an automated trashcan rover system includes an automated trashcan rover device for transporting a trashcan.

To facilitate movement, the device includes at least a pair of tires and motor capable of rotating the tires for movement of the device.

The disclosed automated trashcan rover system fulfills the need for an automatic trashcan transportation device.

Among other things, it is an advantage of the disclosed automated trashcan rover system to provide an automated trashcan rover device that does not suffer from any of the problems or deficiencies associated with prior solutions.

It is still further an advantage of the disclosed automated trashcan rover device to be smartphone compatible and coupled to the device via an application for control and operation of the rover device. The application having settings and configured to alternately synchronize with additional devices, such as a garage door. Accordingly, the application can control settings related to the device, such as, the location, future scheduling, including, but not limited to, a day and/or time for placement and return of the trashcan. The application and device further configured for coupling with accessories electronics, wherein movement of the device or remote may operate the opening or closing of barrier, such as, but not limited to a gate or a garage door.

Still further, the disclosed automated trashcan rover system includes a charging dock for receipt, storage, and charging a power source of the rover device when not in use.

Various embodiments and implementations described in the present disclosure may include additional aspects, capabilities, methods, features, and advantages, which may not necessarily be expressly disclosed herein but will be apparent to one of ordinary skill in the art upon examination of the following detailed description and accompanying drawings. It is intended that all such systems, methods, features, and advantages be included within the scope of this application and protected by the accompanying claims.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a side view of an illustrative automated trashcan rover system comprising an automated trashcan rover device and a charging dock, along with an associated trashcan, according to embodiments described herein.

FIG. 2 is an opposite side view of the illustrative automated trashcan rover system, according to embodiments described herein.

FIG. 3 is a rear view of the illustrative automated trashcan rover system, according to embodiments described herein.

FIG. 4 is a front view of the illustrative automated trashcan rover system, according to embodiments described herein.

FIG. 5 is a top view of the illustrative automated trashcan rover system, according to embodiments described herein.

FIG. 6 is a bottom view of the illustrative automated trashcan rover system, according to embodiments described herein.

FIG. 7 is a perspective view of the illustrative automated trashcan rover system, according to embodiments described herein.

FIG. 8 is an alternate perspective view of the illustrative automated trashcan rover system, according to embodiments described herein.

FIG. 9 is a side view of the illustrative automated trashcan rover device, according to embodiments described herein.

FIG. 10 is a perspective view of the illustrative automated trashcan rover device, according to embodiments described herein.

FIG. 11 is an alternate perspective view of the illustrative automated trashcan rover device, according to embodiments described herein.

FIG. 12 is an additional side view of the illustrative automated trashcan rover device showing additional aspects, according to embodiments described herein.

FIG. 13 is a GUI diagram showing the display of an automated trashcan rover app on a screen of a smartphone or other portable computing device, according to embodiments presented herein.

FIG. 14 is a system diagram showing components of the illustrative automated trashcan rover system, according to embodiments presented herein.

### DETAILED DESCRIPTION

The following detailed description is directed to apparatuses, systems, and methods for implementation of an automated trashcan rover. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purpose

According to some embodiments, an automated trashcan rover system includes an automated rover device or robotic transporter for a trash container that includes a controller for coupling to a smartphone through an application for controlling and directing the movement of the robotic device.

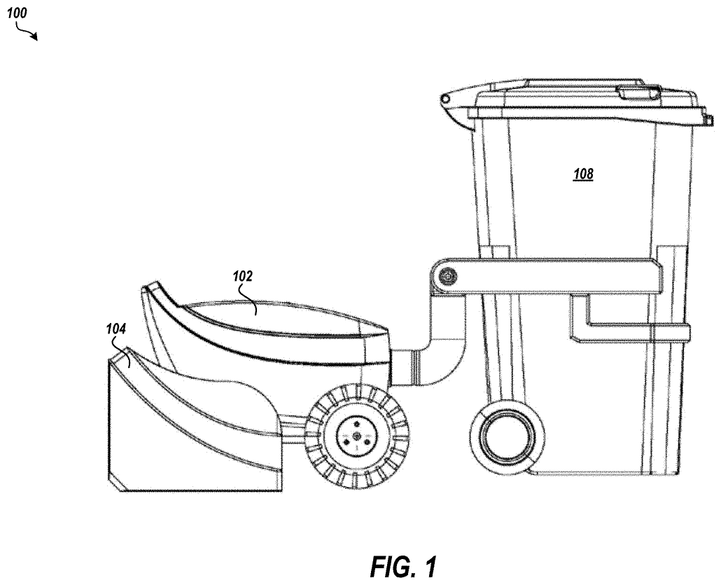

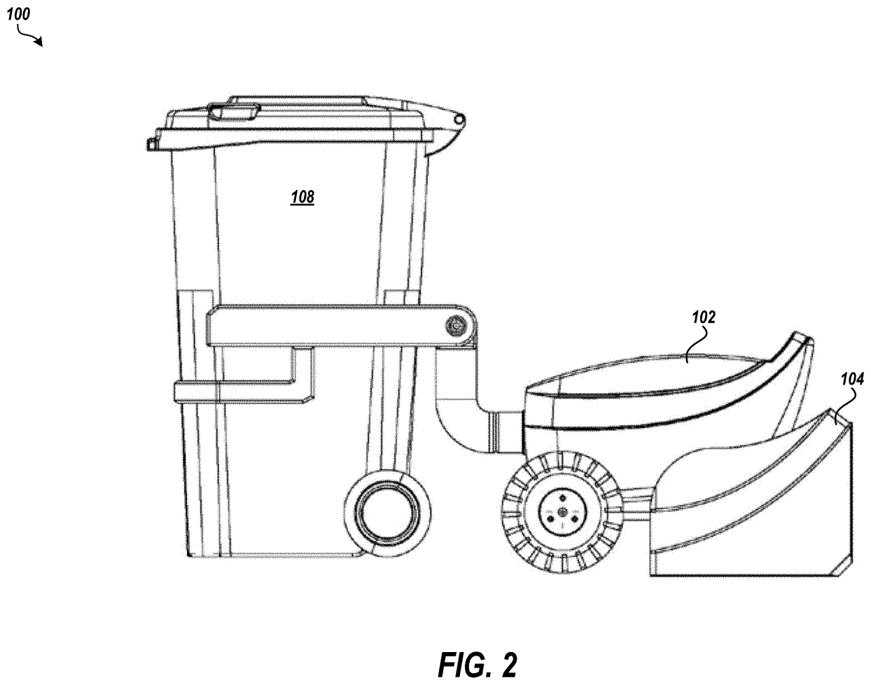

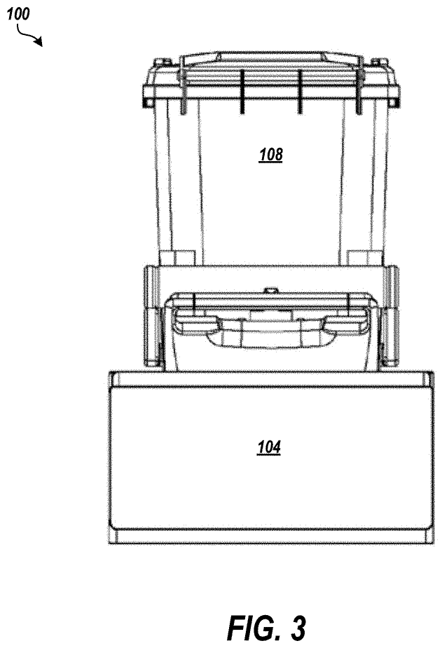

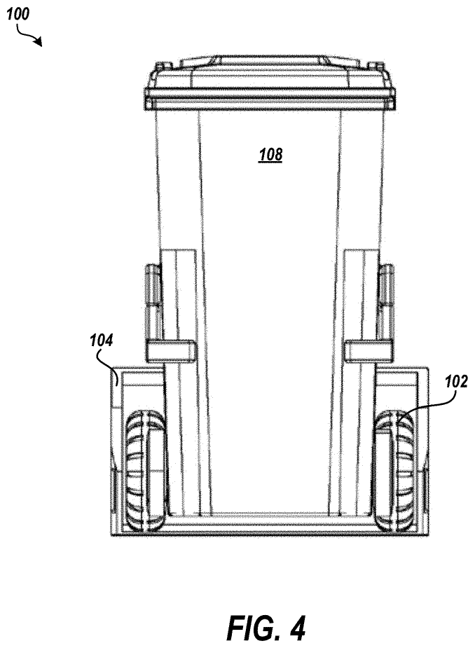

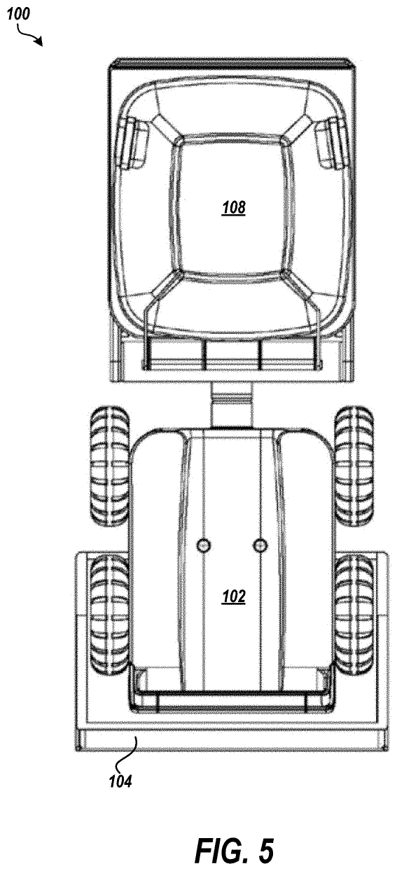

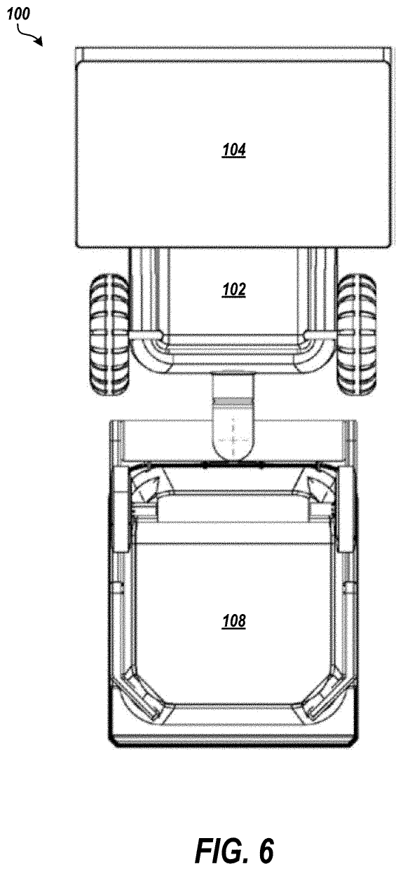

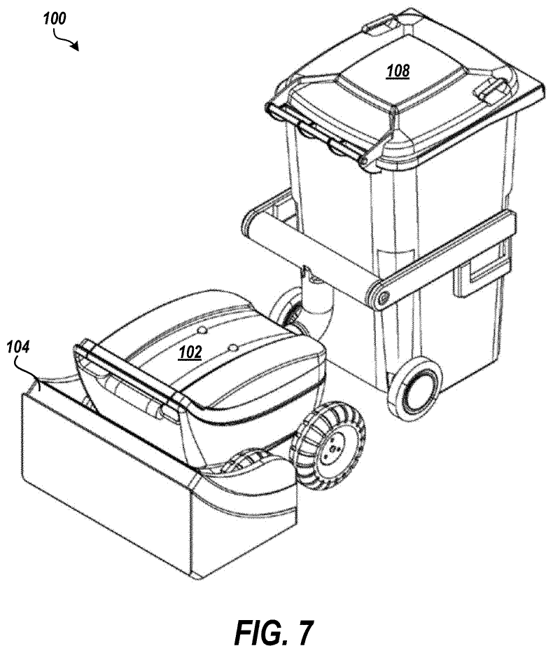

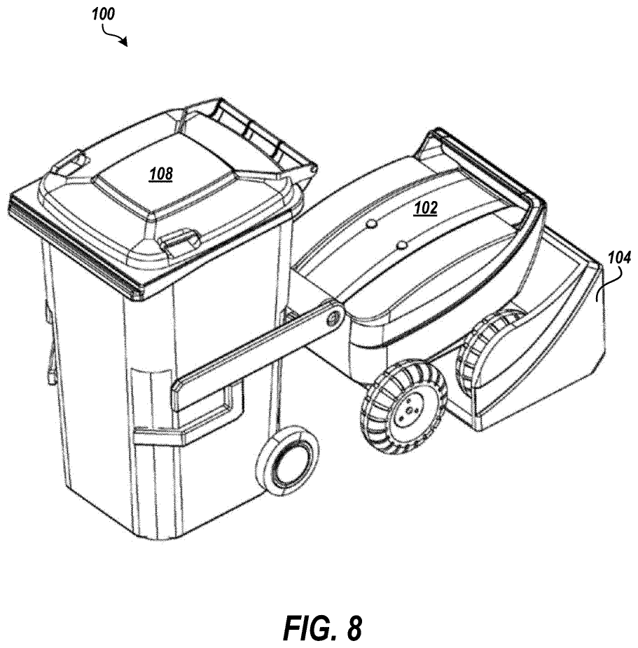

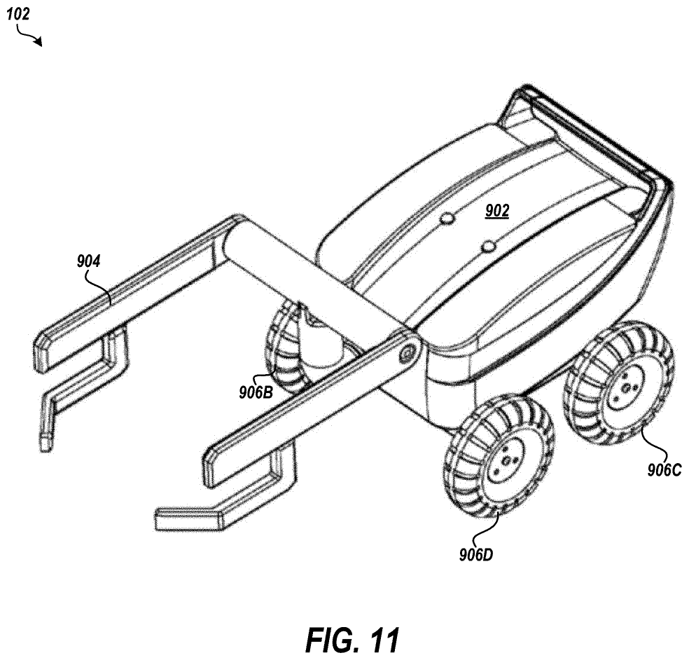

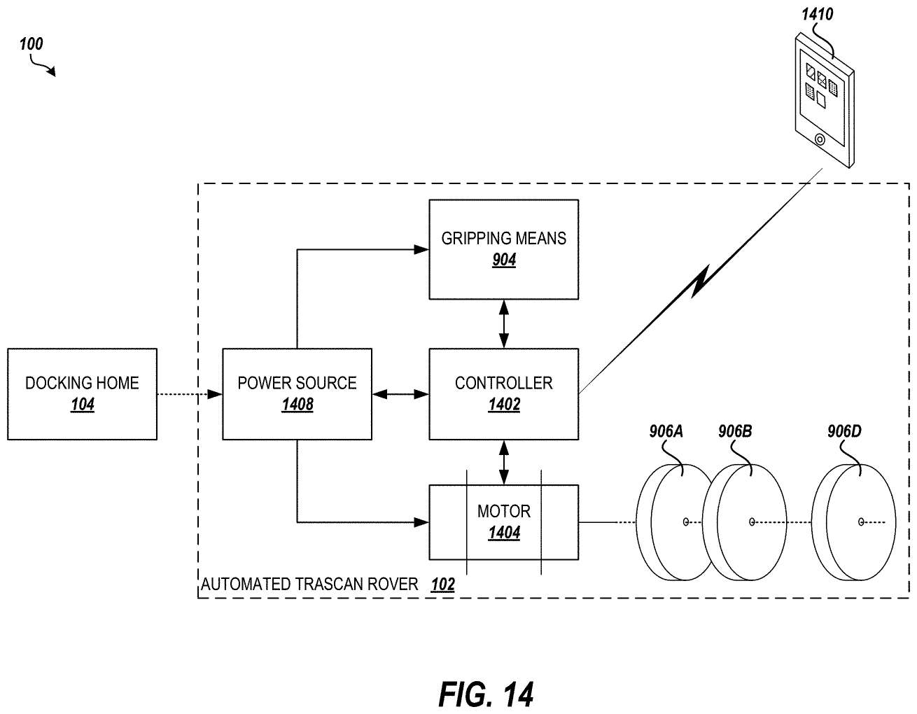

Referring now to the figures, FIGS. 1-11 show an automated trashcan rover system 100 and device 102 according to the present disclosure. According to some embodiments, the automated trashcan rover system 100 comprises an automated trashcan rover device 102 and a docking station or “docking home” 104. The automated trashcan rover device 102 comprises a robotic rover 902 comprised of at least a power source 1408, a motor 1404 coupled to the power source, a gripping means 904, and a plurality of wheels, such as wheels 906A-906D, coupled to the motor, and a controller 1402 configured to control and direct movement of the device. The device controller 1402 is generally configured for coupling to an application, or “app,” hosted on a smartphone, such as smartphone 1410 shown in FIG. 14, or other personal electronic device to facilitate direction and operation of the automated trashcan rover system 100, including, but not limited to, movement, charging, lifting, positioning, and scheduling of the automated trashcan rover device 102, and the operation of additional devices. Accordingly, the automated trashcan rover system 100 may include additional structural and electronic components to facilitate operation.

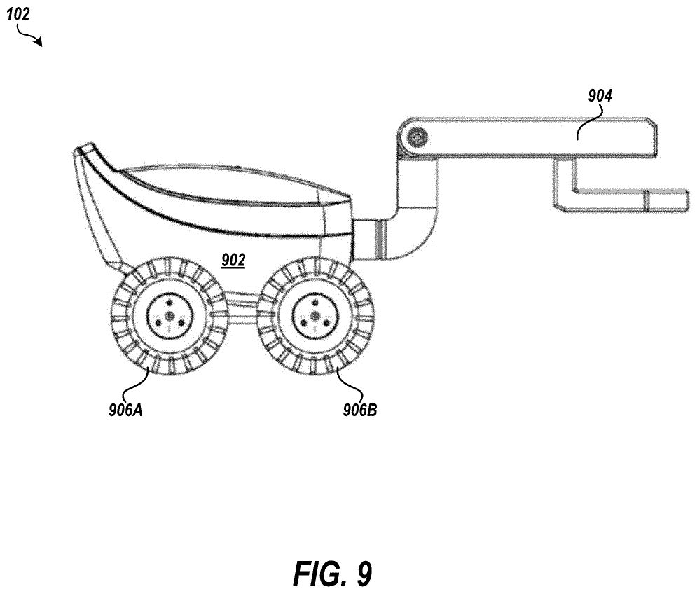

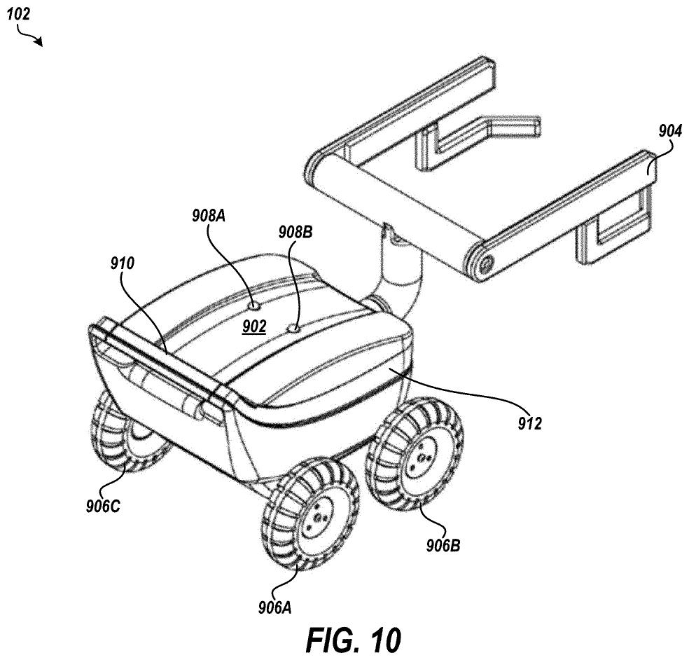

The automated trashcan rover device 102, in alternate embodiments, may include a handle 910, lighting elements, such as, but not limited to LED indicators 908A and 908B, and reflective striping 912. The gripping means 904, preferably a pair of arms such as main arm assembly shown in FIGS. 9 and 10, is preferably capable of both grasping and lifting and configured to surround and secure a trashcan 108 (also referred to herein as trash bin 108) for lifting and moving. Accordingly, the automated trashcan rover device 102 will generally maneuver to a trashcan 108 upon direction and utilize the gripping means 904 to both secure and lift the trashcan 108. The automated trashcan rover device 102 will then drive/move the trashcan 108 to a desired position for collection, release the trashcan, return to the docking home 104 assembly, and generally repeat the process after the trash has been collected.

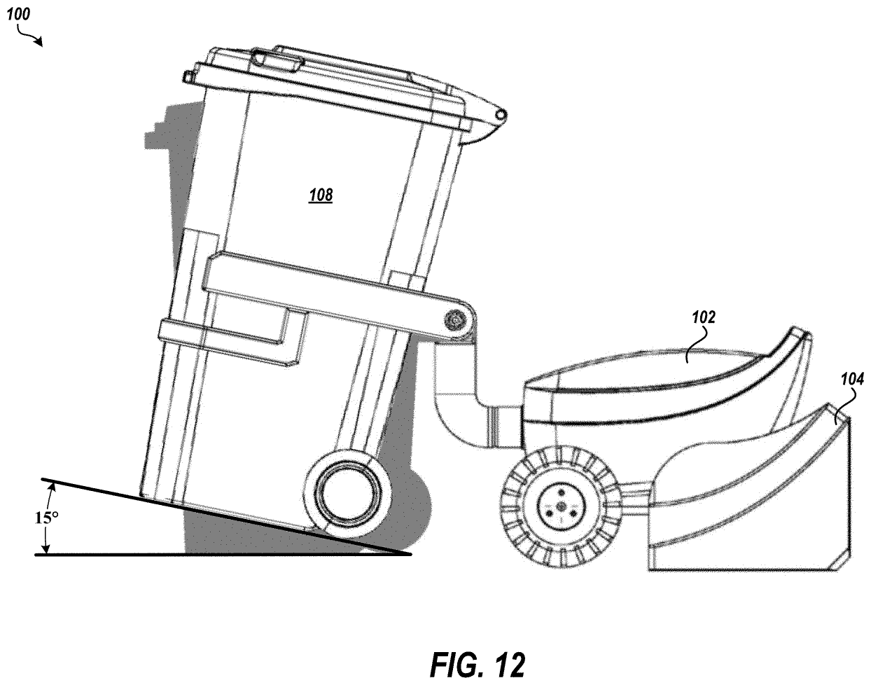

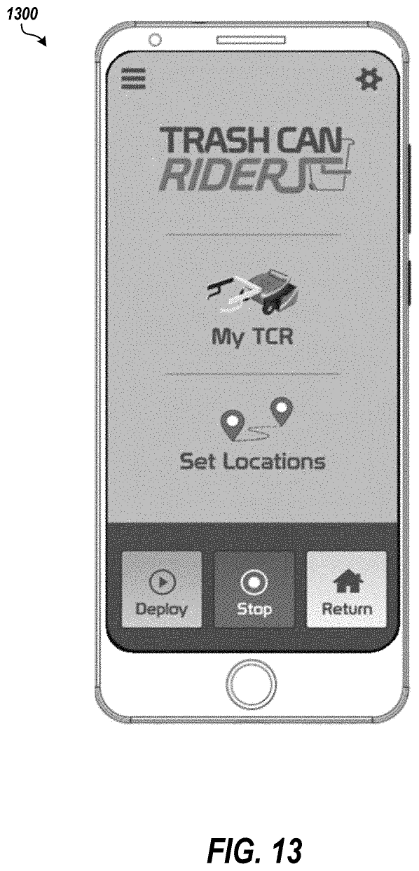

According to further embodiments, additional features/functions of the automated trashcan rover device and system may include:
Automated trashcan rover system 100 may be easily programmed to carry trash bins 108 from the docking home 104 to the curb collection point, and then back to the docking home again according to pre-programmed schedule or manually deploying via smartphone app or remote-control device.
Automated trashcan rover device 102 may include multiple LED indicators, such as indicators 908A and 908B shown in FIG. 10, to indicate various status information. For example, the automated trashcan rover device 102 may include a red LED indicator 908A that illuminates when the device needs attention, and a blue LED indicator 908B that illuminates when the device is engaged.
Automated trashcan rover device 102 may include a textured handle 910 that provides easy grip when the device is manually moved.
Automated trashcan rover system 100 may include a docking home 104 that houses and charges the automated trashcan rover device 102 when not in use as well as calibrates the device's starting location for operation.
Automated trashcan rover device 102 may include reflective striping, such as striping 912 shown in FIG. 10, on all sides for safe visibility in the dark.
Wheels 906A-906D of the automated trashcan rover device 102 may be fitted with all-terrain or “fat” tires to allow operation in various terrain and weather conditions. Studded tires may be available separately.
Main arm assembly 904 of the automated trashcan rover device 102 may be configured to universally fit national industry standard trash bins 108 to easily locate, grip, and lifts trash bins.
Automated trashcan rover device 102 may be stationed in the docking home 104. The docking home 104 can be conveniently located in a garage or near the home for daily trash filling. When deployed, the automated trashcan rover device 102 carries the trash bin 108 to the predetermined trash collection point. After collection, the automated trashcan rover device 102 will return to the docking home 104 with the empty trash bin 108 and recharge until the next collection day.
When carrying trash bins 108, the automated trashcan rover device 102 can lift and tilt the bin, to a configured tilt angle based on weight, up to 15 degrees, to counter the weight of the trash inside, as shown in FIG. 12. This provides better ground clearance and improves the center of gravity ensuring the unit will not tip or spill.
Automated trashcan rover system 100 may include a smartphone application, or “app”, that allows the user to set the dock and collection locations for accurate placement and return. The user can also schedule collection date/times or manually deploy the device even when away from home. An example user interface 1300 for the app is shown in FIG. 13.
Automated trashcan rover system 100 may include a physical remote-control device (not shown) as an alternative method to the smartphone app for a more basic control device.
The smartphone app and/or the remote-control device may also sync with the user's garage door opening system so that the deployment sequence of the automated trashcan rover device 102 includes opening and closing the garage door for complete automated functionality.
Docking home 104 and collection location can be programmed for accurate deployment and precise placement.
The gripping means 904 may include a weight detection mechanism that knows when the trashcan 108 is empty or loaded. The application may alert a user if the garbage has not been taken yet.
The automated trashcan rover device 102 may further include object or barrier detection capability that allows for the alerting of a user if there is an object like a car blocking the way of the rover.
The automated trashcan rover device 102 may further include a loud anti-theft alarm and sensor that will notify a user audibly and thru the application if someone tries to move the rover outside of a geofenced area.

Based on the foregoing, it should be appreciated that technologies for implementation of an automated trashcan rover are described herein. The subject matter described above is provided by way of illustration only and should not be construed as limiting. Various modifications and changes may be made to the subject matter described herein without following the example embodiments and applications illustrated and described, and without departing from the true spirit and scope of the present invention.

What is claimed is:

1. An automated trashcan rover device for lifting and moving a trashcan, comprising:
a plurality of wheels;
a motor coupled to the plurality of wheels;
a gripping means configured to grasp and lift the trashcan;
a controller coupled to the motor and the gripping means and configured to control the lifting and moving of the trashcan; and
a power source coupled to the motor, gripping means, and controller and configured to supply power for the operation of the device.

2. The automated trashcan rover device of claim 1, wherein the automated trashcan rover device is configured to be housed in a docking home when idle and the power source is configured to receive electrical charge from the docking home when the automated trashcan rover is housed therein.

3. The automated trashcan rover device of claim 2, where the controller is configured to, upon a pre-programmed schedule or manual activation by a smartphone app or remote-control device:
lift the trashcan by the gripping means;
control the motor coupled to the plurality of wheels to transport the trashcan from a location of the docking home to a collection location for the trashcan; and
return the trashcan from the collection location to the location of the docking home after trash collection.

4. The automated trashcan rover device of claim 2, wherein the controller is coupled to an application executing on a smartphone or other personal electronic device configured to direct and operate the automated trashcan rover device.

5. The automated trashcan rover device of claim 4, wherein the application is further configured to operate a garage door opener at a premises of the automated trashcan rover device in order to facilitate operation of the automated trashcan rover device.

6. The automated trashcan rover device of claim 4, wherein the location of the docking home and the collection location are programmed in the application prior to operation of the automated trashcan rover device.

7. The automated trashcan rover device of claim 1, wherein the gripping means comprises a pair of arms configured to universally grasp and lift national industry standard trashcans.

8. The automated trashcan rover device of claim 1, wherein the plurality of wheels comprises four wheels.

9. The automated trashcan rover device of claim 1, further comprising one or more LED indicators to indicate status information of the automated trashcan rover device.

10. The automated trashcan rover device of claim 1, further comprising a handle for manually moving the automated trashcan rover device.

11. An automated trashcan rover system, comprising:
an automated trashcan rover device comprising
a plurality of wheels,
a motor coupled to the plurality of wheels,
a gripping means configured to grasp and lift a trashcan,
a controller coupled to the motor and the gripping means and configured to control the lifting and moving of the trashcan, and
a power source coupled to the motor, gripping means, and controller and configured to supply power for the operation of the automated trashcan rover device;
a docking home configured to house the automated trashcan rover device when idle and to provide electrical connections for recharging of the power source; and
an application executing on a smartphone or other personal electronic device and coupled to the controller, the application configured to direct and operate the automated trashcan rover device.

12. The automated trashcan rover system of claim 11, where the controller is configured to, upon a pre-programmed schedule or manual activation by a user through the application:
lift the trashcan by the gripping means;
control the motor coupled to the plurality of wheels to transport the trashcan from a location of the docking home to a collection location for the trashcan; and
return the trashcan from the collection location to the location of the docking home after trash collection.

13. The automated trashcan rover system of claim 11, wherein the controller is further configured to lift and tilt the trashcan to a configured tilt angle between 1 and 15 degrees based on a weight of the trashcan to provide ground clearance and center of gravity for the combined automated trashcan rover device and trashcan to allow for safe transport of the trashcan.

14. The automated trashcan rover system of claim 11, wherein the plurality of wheels comprises four wheels.

15. The automated trashcan rover system of claim 11, wherein the automated trashcan rover device further comprises one or more LED indicators to indicate status information of the automated trashcan rover device.

16. An automated trashcan rover device comprising:
a plurality of wheels;
a power source;
a motor coupled to the wheels and the power source and configured to maneuver the automated trashcan rover device;
a gripping means configured to grasp and lift a standard trashcan; and
a controller coupled to the power source, the motor, and the gripping means and configured to:
grasp and lift the trashcan by the gripping means;
transport the trashcan from a home location to a collection location for the trashcan by the motor and plurality of wheels; and
return the trashcan from the collection location to the home location after trash collection.

17. The automated trashcan rover device of claim 16, wherein the controller is further configured to perform the grasping, transporting, and returning under the direction of a remotely coupled smartphone app.

18. The automated trashcan rover device of claim 17, wherein the controller is further configured to perform the grasping, transporting, and returning based on a pre-programmed schedule or upon manual activation by a user through the smartphone app.

19. The automated trashcan rover device of claim 17, wherein the home location and the collection location are pre-programmed in the smartphone app prior to operation of the automated trashcan rover.

20. The automated trashcan rover device of claim 17, wherein the smartphone app is further configured to operate a garage door opener at a premises of the automated trashcan rover device in order to facilitate operation of the automated trashcan rover device.
